(19) United States
(12) Patent Application Publication
(10) Pub. No.: US 2026/0237158 A1
(43) Pub. Date: Aug. 13, 2026

(54) DEVICE COLOCALIZATION FOR SHARED AUGMENTED REALITY

(71) Applicant: Niantic Spatial, Inc., San Francisco, CA (US)

(72) Inventors: Richard Wu, Sunnyvale, CA (US); Guy-Richard Kayombya, Bethesda, MD (US)

(21) Appl. No.: 19/049,914

(22) Filed: Feb. 10, 2025

(51) Int. Cl. G06T 17/20; A63F 13/52

(52) U.S. Cl. CPC G06T 17/205; A63F 13/52

(57) ABSTRACT

A first mesh of a field of view of a first client device in a first coordinate system is received. The first mesh is generated by the first client device from a depth map. A position of a second client device in the field of view of the first client device in the first coordinate system is received. A second mesh of a field of view of the second client device and a location of the second client device in a second coordinate system is received. The second client device is colocalized to the first coordinate system of the first client device for a shared virtual experience between the first and second client devices by identifying a transformation for mesh alignment of the second mesh to the first mesh based on the position of the second client device in the first coordinate system.

### BACKGROUND

### 1. Technical Field

The subject matter described relates generally to augmented reality, and, in particular, to colocalizing devices into a shared coordinate space for augmented reality.

### 2. Problem

Augmented reality (AR) has seen rapid advancement in recent years, prompting a surge in the development of devices and applications that encourage digital interaction within the real world. By overlaying digital constructs onto the user's view of the physical world, AR has opened new avenues for immersive, interactive experiences. Early forms of these experiences have often been isolated, conducted by individuals using a single device. However, the potential for shared AR experiences that are seamlessly integrated across multiple devices is quickly emerging.

Despite the continuous advancement in AR technology, certain limitations hinder the full realization of shared augmented reality experiences. A core challenge lies in the task of enabling disparate AR devices to perceive and interpret their surroundings in a cohesive, unified manner. The coordinate system—essentially the virtual three-dimensional space understood by the device—varies from one device to another. For a truly shared AR experience, these disparate coordinate systems need to be synchronized or colocalized into a common coordinate system. This would permit the spatial and temporal alignment of AR or virtual elements, allowing users of all participating devices to see and interact with the same virtual objects from the correct perspectives.

Colocalization is technically challenging to perform in a shared or network-based environment due to the enormous computational power required to continuously identify the transformations between coordinate spaces of user devices participating in the shared AR experience to maintain the colocalized state. Transmission of mesh sample data from each device over the network for the colocalization also creates the problem of significant network bandwidth consumption and burdensome storage requirements.

### SUMMARY

This disclosure pertains to creating shared Augmented Reality (AR) experiences across multiple devices, including devices where the RGB camera feed is unavailable. Techniques disclosed herein look to create a common “colocalized” Augmented Reality (AR) session, allowing for interaction across different devices and user coordinate systems.

In some embodiments, participating devices connect to a centralized server that allows for the interchange of spatial data. Each device may then send to the server its pose and/or mesh data, framed within its own coordinate system. Participating users that are using an AR headset (e.g., a device where the RGB camera feed may be unavailable) may further provide position information of peer devices by, e.g., pointing and clicking on a peer user in an AR interface using a remote to mark their position on the screen.

Using this user-supplied hint (the marked position), the system determines a coarse initial estimate of the transformation essential to colocalize the peer device to the headset. In some embodiments, an additional user hint may be provided to the system with respect to the position of the peer device to solve for the desired transform. Post-initial alignment, the system persistently refines the colocalization process by running mesh alignment and mitigating potential drift from the devices.

By reducing dependency upon individual device capabilities, particularly RGB camera feed availability, this disclosure enables shared AR experiences across a broader range of devices. Moreover, by incorporating the user-supplied hint into the process, the system significantly reduces the amount of computational power, network bandwidth, and storage capacity required to perform the colocalization process and enable the shared AR experience.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for device colocalization for shared AR, according to one embodiment.

FIG. 4 is a block diagram of a colocalization module, according to one embodiment.

FIG. 5 is a diagram illustrating colocalization and transformation by an initial transformation module using two user-supplied hints, in accordance with one or more embodiments.

FIGS. 6A-6E are diagrams illustrating colocalization and transformation by an initial transformation module using one user-supplied hint, in accordance with one or more embodiments.

FIG. 7 is a flowchart of a process for device colocalization for shared AR, according to one embodiment.

FIG. 8 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where device colocalization for shared augmented reality is desirable. In addition, the inherent flexibility of computer-based systems allows for a great variety of possible configurations, combinations, and divisions of tasks and functionality between and among the components of the system.

### Example Location-Based Parallel Reality Game

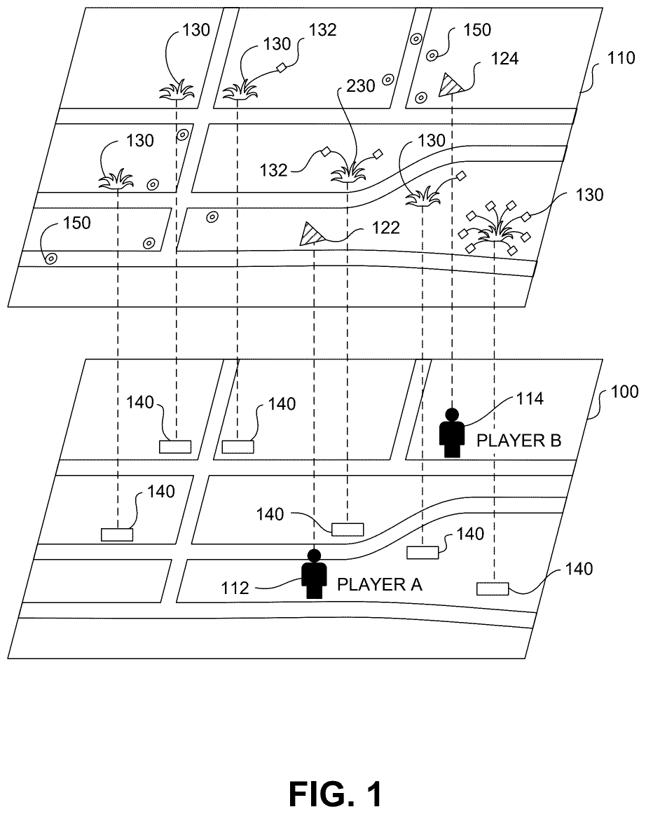

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, people, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as making a gesture, taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

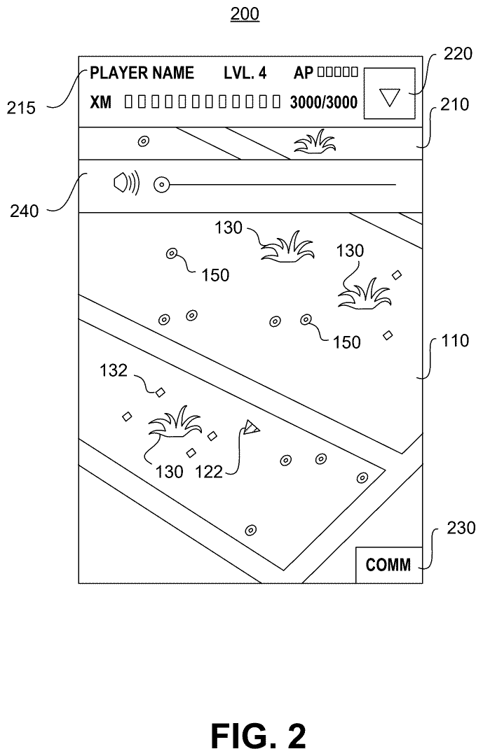

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

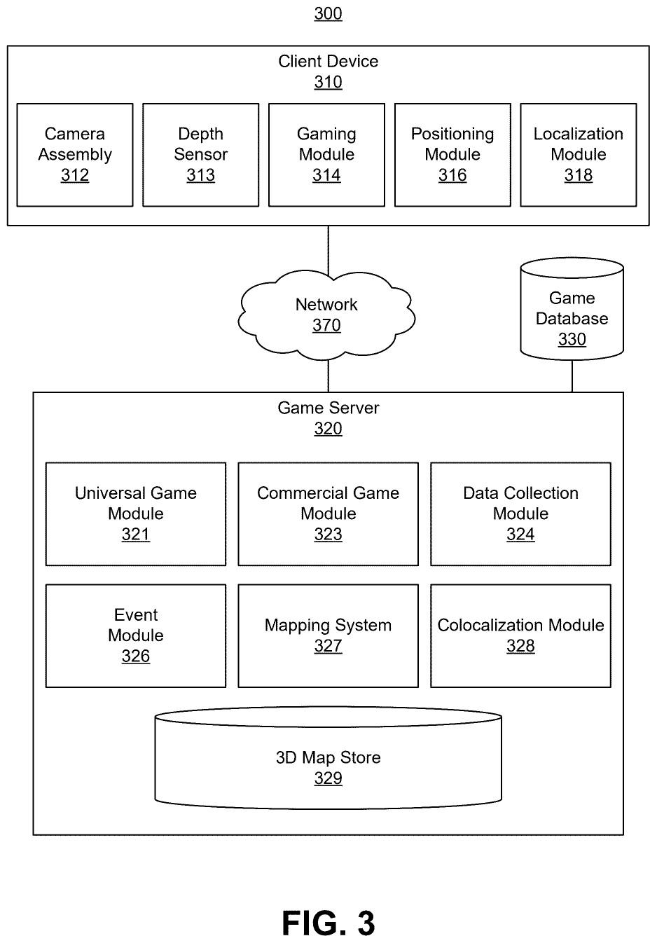

FIG. 3 illustrates one embodiment of a networked computing environment 300. The networked computing environment 300 uses a client-server architecture, where a game server 320 communicates with a client device 310 over a network 370 to provide a parallel reality (e.g., augmented reality) game to a player at the client device 310. The networked computing environment 300 also may include other external systems such as sponsor/advertiser systems or business systems. Although only one client device 310 is shown in FIG. 3, a plurality of client devices 310 or other external systems may be connected to the game server 320 over the network 370 to enable a multi-player experience in shared AR. Furthermore, the networked computing environment 300 may contain different or additional elements and functionality may be distributed between the client device 310 and the server 320 in different manners than described below.

The networked computing environment 300 provides for the interaction of players in a virtual or AR world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a depth sensor 313, a gaming module 314, a positioning module 316, a localization module 318, and an interface 350. The client device 310 also includes a network interface (not shown) for providing communications over the network 370. In various embodiments, the client device 310 may include a subset of the illustrated components, or may include different or additional components, such as additional sensors, display, and software modules, etc.

The camera assembly 312 includes one or more cameras which can capture image data (e.g., RGB image data). The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The depth sensor 313 may include a light detection and ranging (LIDAR) sensor, an infrared sensor, and the like. The depth sensor 313 may output sensor data and use the sensor data to generate a depth map of a scene or field of view captured by the client device 310. The depth map may be an image or image channel that contains information relating to the distance of the surfaces of scene objects from a viewpoint of the client device 310.

The client device 310 may also include additional sensors for collecting data regarding the environment surrounding the client device, such as movement sensors, accelerometers, gyroscopes, barometers, thermometers, light sensors, microphones, range imaging, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The gaming module 314 may take different forms and provide different functionality based on the type of client device 310 the gaming module 314 is installed on. For example, in the case where the client device 310 is a smart phone, the gaming module 314 may be a smartphone application downloadable from an app store associated with an operating system of the smart phone and may include user interfaces the user of the smartphone can interact with by operating the touchscreen of the smartphone. By operating the touchscreen, the user of the smartphone may be able to interact with virtual game elements in an AR view of the user's surroundings displayed in the AR user interface of the gaming module 314.

In the case where the client device 310 is an AR headset, the gaming module 314 may be an app downloadable from an app store associated with the AR headset's operating system and may include AR user interfaces and features that leverage the functionality provided by a fully immersive experience of an AR headset. For example, the AR headset may be paired with a peripheral device (e.g., a remote control) and while using the AR headset, the user may be able to point and click with a remote to another user or device 310 in the user's field of view while using the AR headset, and this user action may cause the AR view of the user's surroundings displayed in the user interface of the gaming module 314 running on the AR headset to display a virtual element (e.g., a laser beam, ray, or another identifier) visually indicating the other user or device 310 in the live AR feed that user of the AR headset has pointed and clicked on. As another example, the user of the AR headset may provide such “point-and-click” input identifying specific other people in the user's field of view while running the gaming module 314 on the AR headset by using other gestures, with or without the user of peripheral devices. For example, the AR headset may be equipped with eye tracking and hand tracking functionality that may identify the portion of the AR view user interface the user is looking at and further identify the person the user is pointing at and display and track an overlaid virtual element on the person in the live AR feed based on the gesture input. The gaming module 314 may further capture the position of the peer user or device input into the user interface by the user of the AR headset by pointing and clicking using a peripheral device, by using some combination of a hand gesture, a finger, or an eye gesture, and the like.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. In some embodiments, RGB image data output of the camera assembly 312 may not be available or accessible to the localization module 318. For example, in instances where the client device 310 is an AR headset, the operating system of the headset may not expose the RGB image data captured by the camera assembly 312 of the AR headset for localization. In such cases, the localization module 318 may rely on the depth map output by the depth sensor 313 to generate a point cloud and a mesh of the surroundings based on the depth map, and further generate or refine a pose of the device 310.

In one or more embodiments, the localization module 318 employs a localization and mapping technique such as Simultaneous Localization and Mapping (SLAM). SLAM works in real-time to construct and update a map of an unknown environment while simultaneously tracking the user's location within that environment. The localization module 318 thus enables precise, real-time adjustments—ensuring a seamless and immersive shared AR experience.

As users explore their surroundings by panning and tilting the camera assembly 312 and/or the depth sensor 313 of their user device 310, the localization module 318 works in the background by scanning the environment (which may be unknown to device 310 and being scanned by the device 310 for the first time) and generating point clouds, which are large sets of data points defined in a three-dimensional coordinate system.

In embodiments where RGB image data captured by the camera assembly 312 is exposed by the client device 310 and made available to the localization module 318, the localization module 318 may utilize the RGB data to generate the point clouds using known techniques.

In embodiments where RGB image data captured by the camera assembly 312 is not exposed by the client device 310 to the localization module 318 (e.g., in the case of AR headsets where the forward facing cameras generate RGB image data feed but this data feed may not exposed to non-native apps for privacy reasons), the localization module 318 may utilize, e.g., the depth map generated based on the sensor data from the depth sensor 313 to generate the point clouds.

These point clouds represent the external morphology of the surroundings, comprising a rich set of depth data that provides a detailed physical context for the AR experience. The localization module 318 may further convert the point clouds into comprehensive 3D meshes, providing a structured and visual representation of the user's surroundings. The meshes uphold the integrity of the depth and spatial nuances of the environment and serve as a foundational framework on which the AR elements can be overlaid.

The localization module 318 may periodically sample the environment to generate the 3D meshes and transmit the meshes, along with positions or ‘pose data’—which constitute the position and orientation of the camera 312, the depth sensor 313 or the device 310 in space—to the central game server 320. This transmission may implement compression algorithms to provide efficient bandwidth usage while maintaining high-quality data conveyance.

By distributing the mesh and pose data from the server 320 to all connected devices 310 and implementing device colocalization as explained in detail below, the system allows all users to exist within the same shared AR experience. Each user perceives the AR elements with correct depth perception and environmental interaction, entirely relative to their independent location within the shared digital space.

In one or more embodiments, the localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to each client device 310. The game server 320 can include or be in communication with a game database 330. The game database 330 stores game data used in the parallel reality game to be served or provided to each client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, a colocalization module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game; all players participating in a shared AR experience) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

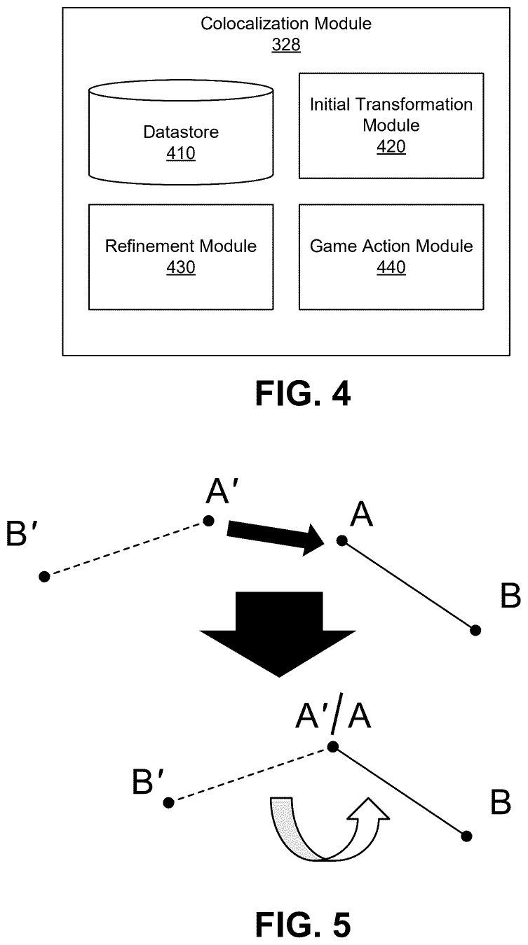

The colocalization module 328 colocalizes two or more client devices 310 into a common coordinate space or system which is then used to inform transformations between individual coordinate systems of the respective devices 310 participating in a shared AR experience. Colocalization allows virtual elements to be placed in an AR feed with correct depth perception and environmental interaction, entirely relative to the independent location and pose of each device 310 within the shared digital space. More specifically, the colocalization module 328 is configured to colocalize devices 310 even in instances where at least at least one of the devices 310 is, e.g., an AR headset that does not expose RGB image data captured by a camera assembly 312 of the AR headset 310 for the colocalization. Architecture and functionality of the colocalization module 328 is described in detail below in connection with FIG. 4.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel. As another example, processes disclosed as being implemented by a server may be implemented in whole or in part by a client device, and vice-versa.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

FIG. 4 is a block diagram of the colocalization module 328 shown in FIG. 3, according to one embodiment. In the embodiment shown in FIG. 4, the colocalization module 328 includes a datastore 410, an initial transformation module 420, a refinement module 430, and a game action module 440. In other embodiments, the colocalization module 328 contains different or additional elements. In addition, the functions may be distributed among the elements in a different manner than described. Also, some or all of the functionality of the colocalization module 328 may be implemented at the client device 310. Conversely, some of the functionality of the client device 310 associated with performing the colocalization may be implemented at the server 320 by, e.g., the colocalization module 328.

The data store 410 stores data received from each client device 310 that is participating in the shared AR experience. The shared AR experience may be a multiplayer experience (e.g., an AR, VR, parallel reality, or mixed reality game; shared virtual experience) including at least two players, each using their own device (e.g., client device 310) to share the AR experience. As explained previously, the client device may be an AR headset, a smartphone, and the like. Thus, the shared AR experience may be between two or more users, each using their own AR headset, or it may be between two or more users, at least one user using an AR headset, and at least one other user using a smartphone.

Each device may periodically (e.g., many times per second) send data to the server 320, and this data may be stored in the datastore 410 for performing colocalization, refining the colocalization, and maintaining the colocalized state. For example, a first one of the users of the shared AR experience may be using an AR headset. The first user may interact with a user interface of the shared AR application on the AR headset to initiate a multiplayer shared AR session. The first user's AR headset may include a depth sensor that generates a depth map of the user's surrounding environment (e.g., field of view) and further generate a 3D mesh of the field of view as explained previously based on the depth map. A pose of the user (e.g., location and orientation information of the AR headset in the mesh or in a point cloud) may also be generated by the AR headset. This process may be repeatedly performed, e.g., many times per second. The generated data (e.g., point cloud, mesh, pose, location, scan data, etc.) may be sent at every predetermined interval by first user's AR headset to the server.

The mesh data or scan data and the pose data generated by the first device will be in a first coordinate system that is native to the first device. The colocalization module 328 may receive the data in the first coordinate system from the first device, where the data represents a mesh of a field of view of the first device, and the mesh is generated by the first device from a depth map. The colocalization module 328 may store the received data in the datastore 410.

While interacting with the user interface on the AR headset to initiate the shared AR session, the user of the AR headset may also input position information of a second user in the first of view of the AR headset. For example, a transparent display of the AR headset may display the real world itself with the user interface of the shared AR application overlaid on the transparent display on top of the real world. The user of the AR headset may interact with this AR view to “point-and-click” on a second user or device worn or held by the second user to provide the position information to the shared AR application on the AR headset. For example, the “point-and-click” hint is calculated by taking a ray that represents the user's point input (such as line that just extends in the direction of the user's remote) and intersecting it with a live depth map. The overlay information of the interface associated with the user's “point-and-click” input may appear to interact with the real world on the transparent display. In some embodiments, the AR application on the AR headset may allow the user to provide the position information of the second user if the second user is within a predetermined distance (e.g., 8 meters) from the AR headset. In some embodiments, the AR application on the AR headset may employ pattern recognition or facial/object detection algorithms to detect and track in real-time one or more people or their handheld or worn devices (e.g., AR headsets, smartphones) in the field of view of the first user and display overlay information in real-time on the transparent display for each detected person (e.g., bounding boxes that track each detected persons face), making it easier for the user to simply toggle through the detected people in the field of view and select one or more of the detected people for colocalization and/or inviting the detected people to join the shared AR experience.

The position information based on the first user's “point-and-click” input (e.g., user-supplied hint, marked position) is recorded in the coordinate system of the first user's device and may be transmitted to the server in real-time. The colocalization module 328 thus receives, in the first coordinate system of the first device, a position of a second device in the field of view of the first device.

As noted previously, each device sends their data (e.g., pose data, scan data, mesh data, point cloud data, location, etc.) to the server. And each device has their own coordinate system for recording mesh data and pose data.

For example, a second one of the users of the shared AR experience may be using an AR headset or a smartphone. The second user may interact with a user interface of the shared AR application on the AR headset or the smartphone to join the multiplayer shared AR session initiated by the first user. The second user's device may use a depth map or RGB image data from the native camera assembly to generate a point cloud or corresponding 3D mesh of the field of view as explained previously. A pose of the user (e.g., location and orientation information of second device in the mesh or in the point cloud) may also be generated by the second device. This process may be repeatedly performed, e.g., many times per second. The generated data (e.g., point cloud, mesh, pose, location, scan data, etc.) may be sent at every predetermined interval by second user's device to the server.

The mesh data or scan data and the pose data generated by the second device will be in a second coordinate system that is native to the second device. The second coordinate system of the second device may be different from the first coordinate system of the first device, thereby necessitating colocalization by the colocalization module 328. Thus, the colocalization module 328 may further receive data in the second coordinate system from the second device, where the data includes a mesh of a field of view of the second device, and a location (e.g., pose) of the second device in the mesh or point cloud in the second coordinate system. The mesh or point cloud may be generated from a depth map or RGB image data by the second device. The colocalization module 328 may store the received data in the datastore 410.

The initial transformation module 420 may determine or identify a coarse initial transformation for mesh alignment of the second mesh from the second device (which is in the second coordinate system) to the first mesh of the first device (which may be an AR headset) in the first coordinate system, based on the position of the second device in the first coordinate system, the position of the second device being received as the user-supplied hint or marked position from the first user of the first device. Based on the coarse initial transformation, the colocalization module 328 may colocalize the second device to the first coordinate system of the first device for the shared AR experience.

In one or more embodiments, the user-supplied hint or marked position may be provided by the user (e.g., using the “point-and-click” functionality described above) more than once. For example, the first user (i.e., user wearing the headset) may provide a first user-supplied hint to the colocalization module 328 as described above, and then the first user may ask the second user to physical move to a different location (e.g., second location) within the field of view of the AR headset's transparent AR display and the first user may then again repeat the process “point-and-click” or gesture or other process to input the new position of the second user in the field of view as a second user-supplied hint or a second marked position. Thus, the colocalization module 328 may further receive from the second device a second location (e.g., second pose) of the second device in the second coordinate system, a second location of the second device being different from the first location, and further receive, in the first coordinate system from the first device, a second position of the second device (i.e., second user-supplied hint or marked position) at the second location in the field of view of the first device. The colocalization module 328 may store the received data in the datastore 410. The received data may be stored in association with each other such that the first position in the first coordinate system (i.e., the first user-supplied hint) is stored in association with the first location in the second coordinate system as a first pair of correspondence, and the second position in the first coordinate system (i.e., the second user-supplied hint) is stored in association with the second location in the second coordinate system as a second pair of correspondence. The initial transformation module 420 may then determine the coarse initial transformation for mesh alignment of the second mesh from the second device to the first mesh of the first device based on the first and second pairs of correspondences stored in the datastore 410.

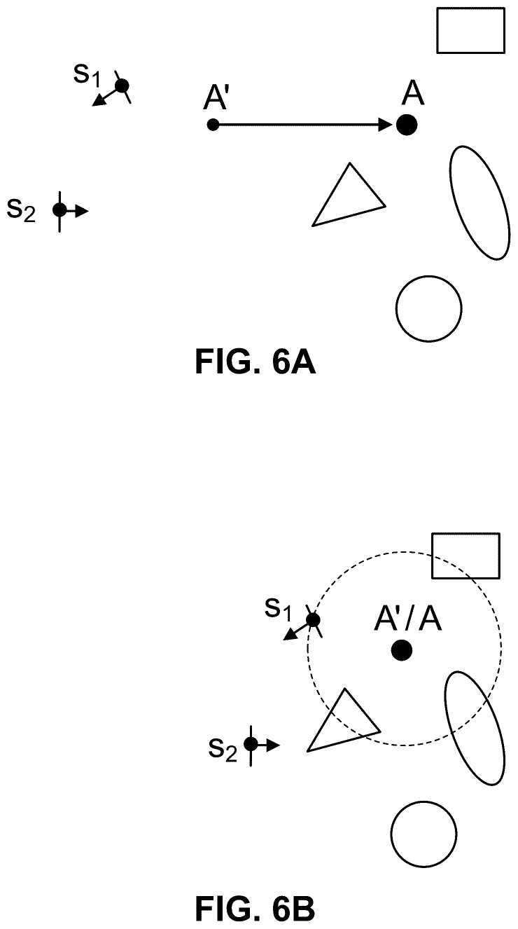

Transformation determination based on the first and second pairs of correspondences is described in greater detail below in connection with FIG. 5. FIG. 5 is a diagram illustrating colocalization and transformation by the initial transformation module 420 when the AR headset user has input two hints with respect to the position of the second device in the first device's field of view (i.e., the colocalization module 328 has received the first and second pairs of correspondences), in accordance with one or more embodiments. The process of colocalization involves finding the transform that takes the second device's local coordinate system to the first device's local coordinate system. One notable property of the devices is that the direction of gravity will always be the negative y-axis. This means that the transform between the two coordinate systems cannot change the direction of gravity. Since the transform must be a rigid transform, there are traditionally 6 degrees of freedom (3 for translation, 3 for rotation). Translations don't affect the direction of the y-axis, but the only possible rotation that does not change the direction of the y-axis is the rotation about the y-axis itself. There are therefore only 4 degrees of freedom to consider for colocalization: the 3 degrees of freedom from translating in 3 dimensions, and the number of degrees to rotate about the y-axis. One consequence of the reduction of possible rotations is that the coarse initial transformation can be determined with only the first and second pairs of correspondences.

In FIG. 5, suppose A and B are the first and second user-supplied hints from the first user in the first coordinate system of the first device, and A′ and B′ are the corresponding points received as the first location and the second location (e.g., pose data) from the second device in the second coordinate system. A and A′ are the same position and B and B′ are the same position, since the location or pose information from the second device was received concurrently and is paired with the position information received from the first device. With the first and second pairs of correspondences, the initial transformation module 420 finds a transform that resolves A′ with A and B′ with B.

FIG. 5 shows a bird's eye view, where the y-axis is coming out of the figure and the two dimensions in FIG. 5 are the x-and z-axes. Since every rotation must be about the y-axis, the rotation can be considered to be a 2D rotation on the x-z plane. Now, the transformation is a combination of a translation and rotation. The translation is just the translation that takes A′ to A (which is just the difference A-A′). The rotation about A can be added and set to the rotation that takes B′ to B, as illustrated in FIG. 5. The coarse initial transform in this case will be determined by projecting the point onto the x-z plane after the translation, and finding the rotation that lines up the direction vector from A′ to B′ (which is B′ +A-A′) to the direction of B-A, when both vectors get projected onto the x-z plane.

When there are three or more participants to the shared AR experience, each user asking the other users to move about to different locations to provide two hints per device might be cumbersome. It is desirable to have the user provide the hint for every other device's location once. In one or more embodiments, the initial transformation module 420 is further configured to determine the coarse initial transformation based on one pair of correspondence between the other device's position in the first coordinate system and concurrent data indicating the location of the other device in the second coordinate system.

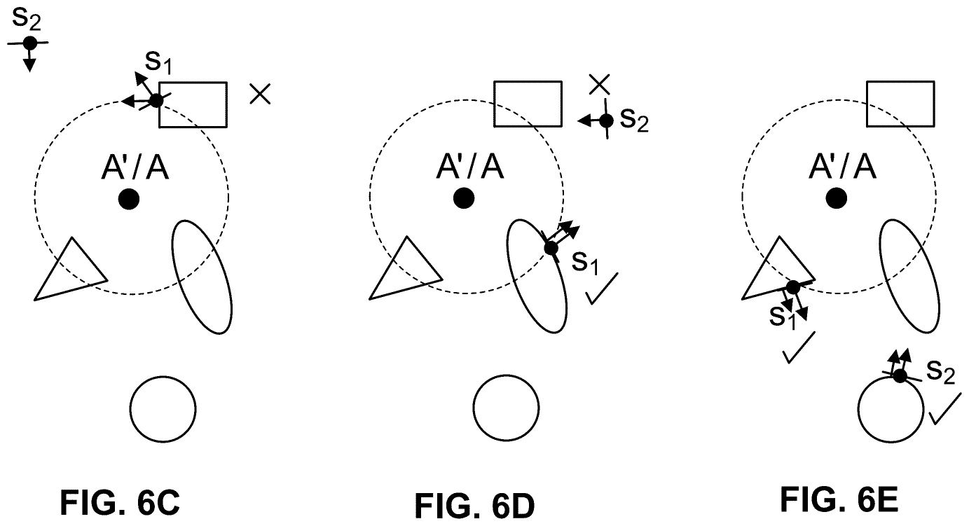

The coarse initial transformation determination by the initial transformation module 420 in instances where a single user-supplied hint is available to the colocalization module 328 is explained in further detail below in connection with FIGS. 6A-6E. FIGS. 6A-6E are diagrams illustrating colocalization and transformation by the initial transformation module 420 when the AR headset user has input one hint with respect to the position of the second device in the first device's field of view (i.e., the colocalization module 328 has received one pair of correspondence), in accordance with one or more embodiments.

In one or more embodiments, the initial transformation module 420 randomly samples two points and their normals from the mesh of the second device having the second coordinate space, and then we iteratively search for an analogous pair of points in the concurrent mesh of the first device having the first coordinate space. The analogous two points in the mesh of the first device should have the same distance as the sampled two points, and their normals should face the same relative directions compared to each other and the line between the two points. The initial transformation module 420 then calculates the transform that takes the sampled two points to the analogous points on the concurrent mesh of the first device and compares the two meshes after applying this transform to the first mesh. The initial transformation module 420 then calculates the Largest Common Pointset (LCP) statistic. This can be done by looping through all the vertices in one mesh and finding the closest point on the other mesh along with the distance between these two points. The initial transformation module 420 may then calculate the fraction of points whose distance to the other mesh lies within a threshold (a small epsilon that is a hyperparameter). The initial transformation module 420 then repeatedly samples points, finding similar candidates, and calculates the LCP for the RANSAC loops. In the end, the initial transformation module 420 outputs the transform that yielded the highest LCP.

To reduce the number of points to sample (thereby improving computational efficiency, reducing network bandwidth, etc.), the initial transformation module 420 takes advantage of the user-supplied hint. Specifically, since the translation for the transform is already available from the user-supplied hint, the initial transformation module 420 only needs to find the rotation about the vertical line through the reference point.

Consider FIGS. 6A-6B, which again show a bird's eye view, where the y-axis protrudes out of the figure and the figures are a projection onto the x-z plane. In FIGS. 6A-6B, the four shapes represent the scene (e.g., mesh or scan) in the first device's (e.g., AR headset) coordinate space (i.e., the first coordinate space), and the point A represents the user-supplied hint, i.e., the position of the second device in the first coordinate space.

Further, A′ represents the corresponding pose (i.e., location information) of the second device received from the second device in the second coordinate space. During the colocalization process, the initial transformation module 420 may receive samples S1 and S2 from the second device in the second coordinate space, with the normals as shown in the figures.

In determining the initial transformation, the initial transformation module 420 first calculates the translation that takes A′ to A, and then tries to find the rotation about A. Note that when the initial transformation module 420 translates A′ to A, it will also apply the same translation to S1 and S2 since A', S1, and S2 are from the same coordinate space of the second device. Applying this translation results in the output shown in FIG. 6B. In other words, the initial transformation module 420 determines a translation from the location of the second device in the second coordinate system (e.g., A′ in FIGS. 6A-6B) to the position of the second device in the first coordinate system (e.g., A in FIGS. 6A-6B), the location of the second client device in the second coordinate system being concurrent to the position of the second client device in the first coordinate system (e.g., the position and the location are captured at substantially the same time by the respective first and second devices).

Now that the translation is set, the initial transformation module 420 iteratively samples points from the second coordinate space to find the rotation about the vertical line through A. That is, the initial transformation module 420 determines a rotation about a vertical line (e.g., y-axis in FIGS. 6A-6E) passing through the position of the second device in the first coordinate system (e.g., A in FIGS. 6A-6E). Given any rotation about a vertical line parallel to the y-axis, the y-coordinate must be preserved, and the distance to this line must also be preserved. The distance between a point and a vertical line is the 2-D Euclidean distance involving the x and z coordinates. In other words, to find the distance from S1 to the vertical line through A, the initial transformation module 420 takes the x and z coordinates of A and S1 and computes the Euclidean distance between those two components.

The initial transformation module 420 tries to find a pair of points in the scene such that a rotation about the vertical line through A takes S1 and S2 to those points. The set of all possible points in the scene that could possibly be S1 must share the same y-coordinate as S1 (after the translation), and the x-z distance from A must be the same as the x-z distance between S1 and A. This is because the x-z distance from A and the y-coordinate cannot change under any rotation about A. Thus, the initial transformation module 420 restricts the search space to the points that would satisfy these conditions.

The set of points that preserve the x-z distance is simply the dotted circle in FIGS. 6B-E. The initial transformation module 420 also restricts the search space to points with a similar y-coordinate as S1. The path forward now becomes clear. We have a circle parallel to the x-z plane with the same y-level as S1, and this circle's radius is the x-z distance between S1 and A, and it will be centered at the point along the vertical line through A with the same y-coordinate as S1. We know that the analogous point to S1 in the scene from the first device in the first coordinate space must lie on this circle, so the initial transformation module 420 simply checks for intersections between the circle and the live mesh of the first device, and then tests those intersections.

The initial transformation module 420 may allow for some error threshold in the intersection of the circle and the mesh, and may implement a function that intersects a torus with a mesh. The initial transformation module 420 then just loops through all of the intersection points returned by the function and check whether or not it fits the sample points. This process is illustrated by the mesh alignments illustrated in FIGS. 6C-6E.

Every intersection point corresponds to a rotation about A. Specifically, it is the rotation about A that would bring S1 to the intersection point. FIG. 6C illustrates rotating both samples so that S1 goes to the first intersection point. For each intersection point, the initial transformation module 420 checks that S1's rotated normal is similar to the normal at the intersection point. In FIG. 6C, this is not the case so the initial transformation module 420 rejects this rotation.

If the initial transformation module 420 find a corresponding point to S1 whose normal also lines up (FIG. 6D), the initial transformation module 420 must also make sure that the rotated version of S2 also matches the scene. This can be done by finding the closest point on the mesh to the rotated version of S2. Then, if the returned distance is lower than some threshold and the corresponding normal is similar to S2's rotated normal, the initial transformation module 420 keep the candidate rotation. Otherwise, the initial transformation module 420 rejects the candidate rotation. In FIG. 6D, the initial transformation module 420 rejects the rotation since there is no point close to the rotated S2.

Finally, in FIG. 6E, the initial transformation module 420 accepts this rotation as a candidate rotation since the rotated normal of S1 lines up with the scene, and the closest point query for the rotated version of S2 is close with a similar normal. Note that if the rotated normal of S2 did not line up, the initial transformation module 420 would reject this rotation.

If there is more than one rotation that is accepted, the initial transformation module 420 tries to pick the rotation with the best fit. To choose the best candidate rotation, the initial transformation module 420 may utilize statistics relating to how well the samples fit the scene that we can be either minimized or maximized. In some embodiments, the initial transformation module 420, for every candidate rotation, calculates the pose distance statistic for the rotated S1 and its corresponding point on the mesh and add that to the pose distance for the rotated S2 and its closest point on the mesh. The initial transformation module 420 only considers candidate rotations where the value of this sum of two statistics is less than a threshold value, and the candidate rotation output by the initial transformation module 420 as the coarse initial transformation (translation and the candidate rotation) may be the one with the smallest sum of two pose distances. A “pose” can abstractly be defined as a position (point) and a direction in 3D space. Here, the point is the location on the mesh and the direction is the normal. Therefore, since the initial transformation module 420 compares a pair of point+normal values, their difference can be measured by converting the point+normal to an abstract pose and measure the pose distance.

Returning to FIG. 4, after the initial transformation module 420 determines the coarse initial transformation (e.g., using first and second user-supplied hints, using only the single user-supplied hint and using, e.g., RANSAC), the refinement module 430 may refine the mesh alignment between the second mesh and the first mesh at every predetermined interval. In one or more embodiments, after determining the coarse initialization for the transformation, the refinement module 430 may use a known technique (e.g., iterative closest point (ICP)) to refine the alignment between the meshes. In one or more embodiments, the refinement module 430 may run ICP in the background continuously (e.g., every predetermined interval) in order to mitigate drift. The refinement module 430 may run ICP after the initial transformation module 420 has first output an initial transform, and the refinement module 430 may rerun ICP only if new mesh chunks are received from the second device. This is because ICP alignment on the same set of mesh data should be idempotent, so running alignment a second time with meshes that have already been aligned may not be required.

By colocalizing the first and second devices using the functionality provided by the initial transformation module 420 and the refinement module 430, the system may maintain in real-time the colocalized state between the first and second devices relative to each user's independent location within the shared digital space, even as each user moves around in the real-world and relative to the other user.

The game action module 440 may perform a game action in the shared AR experience based on the refined mesh alignment continuously performed in real-time by the refinement module 430. For example, the game action may be presenting virtual content on the colocalized first and second devices in the shared AR experience. In some embodiments, the functionality provided by the colocalization module 328 may make for an AR experience which is less isolating to the user. For example, a first user may use an AR headset to play a game in a fully immersive AR environment, and one or more other users (using AR headsets or smartphones) who are colocalized to the first user's coordinate space may watch as spectators the first user playing the fully immersive AR game. Everyone may be able to move about in the real world while holding or wearing their respective AR devices and the system may still be able to maintain colocalized and consistent perception for each user for the AR elements in the shared AR space with correct depth perception and environmental interaction, entirely relative to their independent location within the shared digital space.

### Example Method

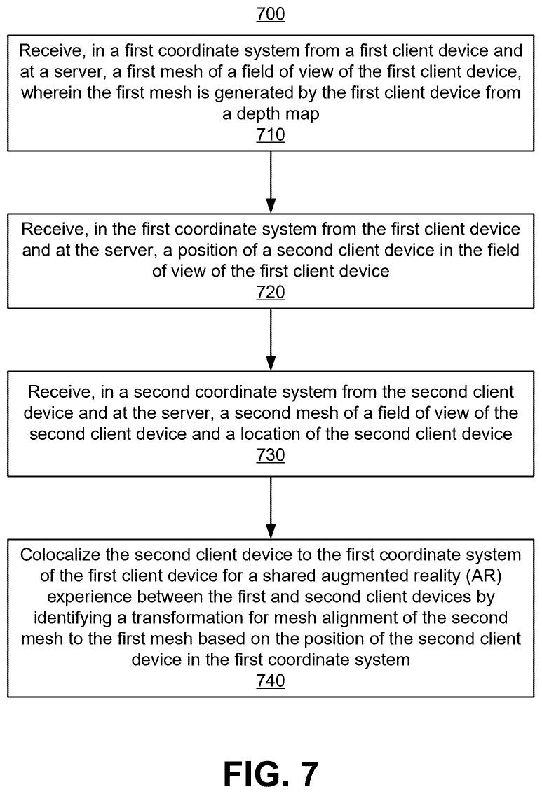

FIG. 7 is a flowchart describing an example method 500 for device colocalization for shared AR, according to one embodiment. The steps of FIG. 7 are illustrated from the perspective of the colocalization module 328 performing the method 700. However, some or all of the steps may be performed by other entities or components. In addition, some embodiments may perform the steps in parallel, perform the steps in different orders, or perform different steps. In the embodiment shown, the method 700 begins by the colocalization module 328 receiving 710, in a first coordinate system from a first client device and at a server (e.g., server 320), a first mesh (e.g., mesh corresponding to point A in FIGS. 5-6) of a field of view of the first client device (e.g., AR headset), wherein the first mesh is generated by the first client device from a depth map (e.g., generated by depth sensor 313 of FIG. 3).

The colocalization module 328 receives 720, in the first coordinate system from the first client device and at the server, a position (e.g., point A in FIGS. 5-6) of a second client device in the field of view of the first client device. The colocalization module 328 receives 730, in a second coordinate system from the second client device and at the server, a second mesh (e.g., mesh corresponding to point A′ and samples S1 and S2 in FIGS. 5-6) of a field of view of the second client device and a location (e.g., point A′ in FIGS. 5-6) of the second client device.

The colocalization module 328 colocalizes 740 the second client device to the first coordinate system of the first client device for a shared augmented reality (AR) experience or shared virtual experience between the first and second client devices by identifying a transformation (e.g., transformation corresponding to FIGS. 5 and 6E) for mesh alignment of the second mesh to the first mesh based on the position of the second client device in the first coordinate system (e.g., point A in FIGS. 5-6; user-supplied hint).

### Example Computing System

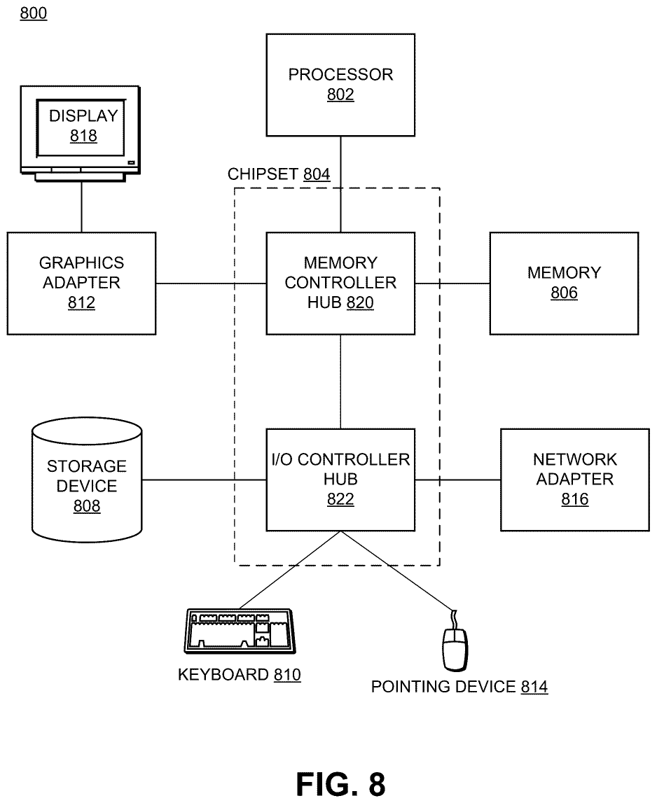

FIG. 8 is a block diagram of an example computer 800 suitable for use as a client device 310 or game server 320. The example computer 800 includes at least one processor 802 coupled to a chipset 804. References to a processor (or any other component of the computer 800) should be understood to refer to any one such component or combination of such components working cooperatively to provide the described functionality. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIGS. 3-4 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method for providing a shared virtual experience between a plurality of client devices, the method comprising:
receiving, in a first coordinate system from a first client device and at a server, a first mesh of a field of view of the first client device, wherein the first mesh is generated by the first client device from a depth map;
receiving, in the first coordinate system from the first client device and at the server, a position of a second client device in the field of view of the first client device;
receiving, in a second coordinate system from the second client device and at the server, a second mesh of a field of view of the second client device and a location of the second client device; and
colocalizing the second client device to the first coordinate system of the first client device for the shared virtual experience by identifying a transformation for mesh alignment of the second mesh to the first mesh based on the position of the second client device in the first coordinate system.

2. The computer-implemented method of claim 1, wherein the transformation is a coarse initial transformation generated based on the received position of the second client device in the first coordinate system, and wherein the method further comprises:
refining the mesh alignment between the second mesh and the first mesh at every predetermined interval; and
performing a game action in the shared virtual experience based on the refined mesh alignment.

3. The computer-implemented method of claim 2, wherein the game action includes presenting virtual content on the colocalized first and second client devices in the shared virtual experience.

4. The computer-implemented method of claim 1, wherein the first client device is an AR headset that does not expose RGB image data captured by a camera assembly of the AR headset for the colocalization.

5. The computer-implemented method of claim 1, further comprising:
providing an AR user interface for a user of the first client device to interactively indicate the position of the second client device on the AR user interface.

6. The computer-implemented method of claim 5, wherein the user may interactively indicate the position of the second client device on the AR user interface of the first client device by pointing and clicking using a remote control paired with the first client device or by using a gesture.

7. The computer-implemented method of claim 1, wherein the first client device includes a depth sensor and wherein the depth map is generated based on sensor data output from the depth sensor.

8. The computer-implemented method of claim 1, wherein colocalizing the second client device to the first coordinate system comprises:
determining a translation from the location of the second client device in the second coordinate system to the position of the second client device in the first coordinate system, the location of the second client device in the second coordinate system being concurrent to the position of the second client device in the first coordinate system; and
determining a rotation about a vertical line passing through the position of the second client device in the first coordinate system.

9. The computer-implemented method of claim 1, wherein the position is a first position received when the second client device is at the location, wherein the location is a first location, and wherein the method further comprises:
receiving, in the second coordinate system from the second client device and at the server, a second location of the second client device that is different from the first location; and
receiving, in the first coordinate system from the first client device and at the server, a second position of the second client device at the second location in the field of view of the first client device.

10. The computer-implemented method of claim 9, wherein colocalizing the second client device to the first coordinate system comprises:
determining the transformation including a translation and a rotation for mesh alignment of the second mesh to the first mesh based on: (i) the first position of the second client device in the first coordinate system and the first location of the second client device in the second coordinate system; and (ii) the second position of the second client device in the first coordinate system and the second location of the second client device in the second coordinate system.

11. A non-transitory computer-readable medium storing instructions that, when executed by a computing system, cause the computing system to perform operations comprising:
receiving, in a first coordinate system from a first client device and at a server, a first mesh of a field of view of the first client device, wherein the first mesh is generated by the first client device from a depth map;
receiving, in the first coordinate system from the first client device and at the server, a position of a second client device in the field of view of the first client device;
receiving, in a second coordinate system from the second client device and at the server, a second mesh of a field of view of the second client device and a location of the second client device; and
colocalizing the second client device to the first coordinate system of the first client device for a shared virtual experience between the first and second client devices by identifying a transformation for mesh alignment of the second mesh to the first mesh based on the position of the second client device in the first coordinate system.

12. The non-transitory computer-readable medium of claim 11, wherein the transformation is a coarse initial transformation generated based on the received position of the second client device in the first coordinate system, and wherein the instructions further cause the computing system to perform operations comprising:
refining the mesh alignment between the second mesh and the first mesh at every predetermined interval; and
performing a game action in the shared virtual experience based on the refined mesh alignment.

13. The non-transitory computer-readable medium of claim 11, wherein the first client device is an AR headset that does not expose RGB image data captured by a camera assembly of the AR headset for the colocalization.

14. The non-transitory computer-readable medium of claim 11, wherein the instructions further cause the computing system to perform operations comprising:
providing an AR user interface for a user of the first client device to interactively indicate the position of the second client device on the AR user interface.

15. The non-transitory computer-readable medium of claim 14, wherein the user may interactively indicate the position of the second client device on the AR user interface of the first client device by pointing and clicking using a remote control paired with the first client device or by using a gesture.

16. The non-transitory computer-readable medium of claim 11, wherein the first client device includes a depth sensor and wherein the depth map is generated based on sensor data output from the depth sensor.

17. The non-transitory computer-readable medium of claim 11, wherein the instructions that cause the computing system to colocalize the second client device to the first coordinate system comprise instructions that cause the computing system to perform operations comprising:
determining a translation from the location of the second client device in the second coordinate system to the position of the second client device in the first coordinate system, the location of the second client device in the second coordinate system being concurrent to the position of the second client device in the first coordinate system; and
determining a rotation about a vertical line passing through the position of the second client device in the first coordinate system.

18. The non-transitory computer-readable medium of claim 11, wherein the position is a first position received when the second client device is at the location, wherein the location is a first location, and wherein the instructions further cause the computing system to perform operations comprising:
receiving, in the second coordinate system from the second client device and at the server, a second location of the second client device that is different from the first location; and
receiving, in the first coordinate system from the first client device and at the server, a second position of the second client device at the second location in the field of view of the first client device.

19. The non-transitory computer-readable medium of claim 18, wherein the instructions that cause the computing system to colocalize the second client device to the first coordinate system comprise instructions that cause the computing system to perform operations comprising:
determining the transformation including a translation and a rotation for mesh alignment of the second mesh to the first mesh based on: (i) the first position of the second client device in the first coordinate system and the first location of the second client device in the second coordinate system; and (ii) the second position of the second client device in the first coordinate system and the second location of the second client device in the second coordinate system.

20. A server for providing a shared virtual experience between a plurality of client devices, the server comprising:
one or more processors; and
a non-transitory computer-readable medium storing instructions that, when executed by the one or more processors, cause the one or more processors to perform operations comprising:
receiving, in a first coordinate system from a first client device and at a server, a first mesh of a field of view of the first client device, wherein the first mesh is generated by the first client device from a depth map;
receiving, in the first coordinate system from the first client device and at the server, a position of a second client device in the field of view of the first client device;
receiving, in a second coordinate system from the second client device and at the server, a second mesh of a field of view of the second client device and a location of the second client device; and
colocalizing the second client device to the first coordinate system of the first client device for the shared virtual experience by identifying a transformation for mesh alignment of the second mesh to the first mesh based on the position of the second client device in the first coordinate system.
